(19) United States
(12) Patent Application Publication
(10) Pub. No.: US 2021/0295283 A1
(43) Pub. Date: Sep. 23, 2021

(54) METHODS AND SYSTEMS FOR BLOCKCHAIN DIGITAL CURRENCY STAKE DELEGATION

(71) Applicant: Visa International Service Association, San Francisco, CA (US)

(72) Inventor: Zi Yu DENG, San Francisco, CA (US)

(73) Assignee: Visa International Service Association, San Francisco, CA (US)

(21) Appl. No.: 16/821,819

(22) Filed: Mar. 17, 2020

(51) Int. Cl. G06Q 20/06; H04L 9/06; G06Q 20/40

(52) U.S. Cl. CPC G06Q 20/0658; G06Q 20/405; H04L 9/0637

(57) ABSTRACT

A computer-implemented method. The method includes accessing details of a transaction from a merchant, determining a stake delegation related to the transaction, determining a stake delegation protocol as defined in a smart contract in accordance with the stake delegation, determining a fee payment type selection for the transaction, implementing and managing the stake delegation protocol and making an entry in a distributed ledger associated with implementation of the stake delegation protocol, and based on the fee payment type selection, making a payment authorization request for the transaction. Accessing a response to the payment authorization request.

### TECHNICAL FIELD

Embodiments of the disclosure pertain stake delegation and, in particular, methods and systems for block chain digital currency stake delegation.

### TECHNOLOGY BACKGROUND

Facebook initiated the Libra™ association to be a global currency (Libra™) and financial infrastructure as a means of empowering billions of people with financial tools heretofore unavailable to them. Libra™ is currently on a journey to transition from permissioned to permission-less governance and consensus in order to lower barriers to entry and innovation, resist censorship attacks, and encourage healthy competition among infrastructure providers.

When Libra™ completes the transition from a permissioned to a permission-less network, any Libra™ holder will be able to become a validator node on the network. However, Libra™ holders who do not wish to take part in the Libra™ network consensus process will be able to delegate this role to entities that they can trust. Presently there are no clearly set forth approaches to role delegation as a bilateral trust mechanism on the Libra network, either in terms of fulfilling Libra™ holders' delegated roles, or maintaining the synchronization of Libra™ holders regarding possible abuse and/or misuse.

### BRIEF DESCRIPTION OF THE DRAWINGS

FIG. 1A shows a diagram of a card payment processing network architecture that includes a graph based cross-domain item recommendation system according to an embodiment.

FIG. 1B illustrates operations performed by a system for blockchain digital currency stake delegation according to an embodiment.

FIG. 2 shows components of a system for blockchain digital currency stake delegation according to an embodiment.

FIG. 3 shows a flowchart of method for blockchain digital currency stake delegation according to an embodiment.

FIG. 4 shows a schematic of a computer system according to an embodiment.

### DESCRIPTION OF THE EMBODIMENTS

The embodiments described herein are not intended to be limited to the specific forms set forth herein. The embodiments are intended to cover such alternatives, modifications, and equivalents that are within the scope of the appended claims.

The detailed description that follows includes numerous specific details such as specific method orders, configurations, structures, elements, and connections have been set forth. It is to be understood however that these and other specific details need not be utilized to practice embodiments. In other embodiments, well-known structures, elements, or connections have been omitted, or have not been described in a manner so as not to obscure this description.

Any reference within the specification to “one embodiment” or “an embodiment” is intended to indicate that a particular feature, configuration, structure, or characteristic described in connection with the embodiment is included in at least one embodiment of the present invention. The appearance of the phrase “in one embodiment” in different parts of the specification can refer to different embodiments. Embodiments described as separate or alternative embodiments are not mutually exclusive of other embodiments. Moreover, various features are described which may be included in some embodiments and not by others. In additions, some requirements for some embodiments may not be required for other embodiments.

In the following description, unless indicated otherwise terms such as “accessing” or “determining” or “implementing” or the like, refer to the operations and processes of a computer system, or similar electronic computing device that manipulates and transforms data represented as physical (electronic) quantities within the computer system's registers and memories and other computer readable media into other data similarly represented as physical quantities within the computer system memories or registers or other such information storage, transmission or display devices.

As used herein the term “stake” is intended to refer to authorized roles and responsibilities that can be delegated by delegators to custodial entities. In an embodiment, as used herein the term “block chain digital currency” is intended to refer to digital currencies that can include but are not limited to Libra™. In an embodiment, the term “block chain digital currency issuer” as used herein can include but is not limited to digital currency issuers such as Facebook™. In an embodiment, the term “digital currency stake delegation network” as used herein is intended to refer to a network of member companies and block chain digital currency holders, whose members are empowered through the network to delegate roles and responsibilities to trusted entities. In an embodiment, as used herein the term “validator” or “validator node” is intended to refer to an entity that runs a consensus protocol, executes the transactions, and stores the transactions and the execution results in a blockchain. In an embodiment, validator nodes decide which transactions will be added to the blockchain and the order in which they will be added.

### Network Architecture

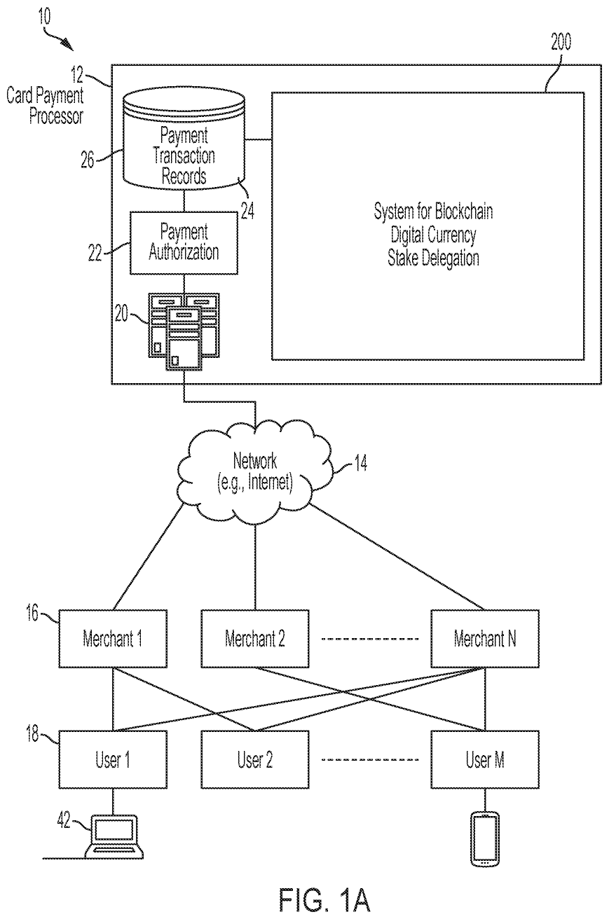

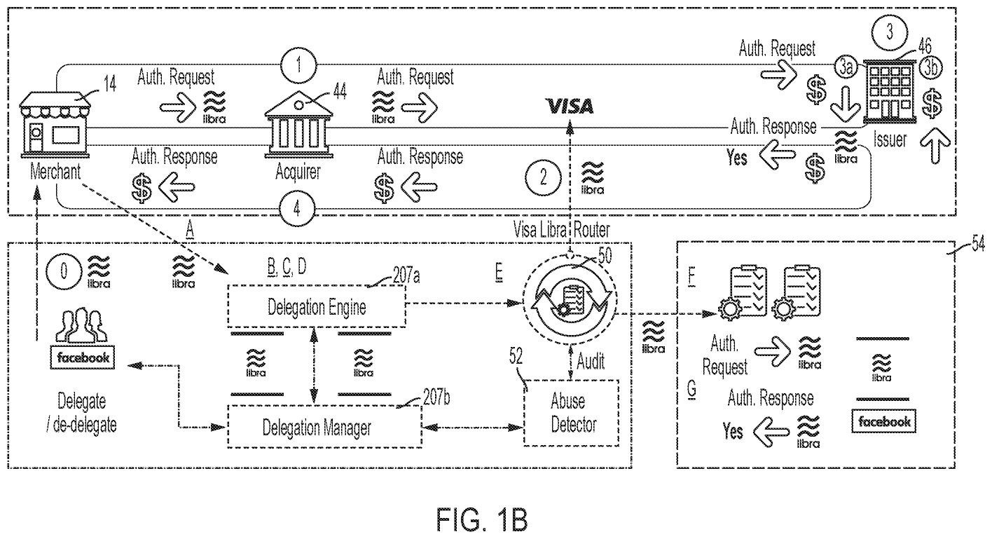

FIG. 1A is a diagram of one embodiment of a card payment processing system in which the disclosed embodiments may be implemented. The card payment processing system 10 includes a card payment processor 12 in communication (direct or indirect) over a network 14 with a plurality of merchants 16. A plurality of cardholders or users 18 purchase goods and/or services from various ones of the merchants 16 using a payment card such as a credit card, debit card, prepaid card and the like. Typically, the card payment processor 12 provides the merchants 16 with a servicer or device that allows the merchants to except payment cards as well as to send payment details to the card payment processor over the network 14. In some embodiments, an acquiring bank or processor (not shown) may forward the credit card details to the card payment processor 12. Payment card transactions may be performed using a variety of platforms such as brick and mortar stores, ecommerce stores, wireless terminals, and mobile devices of the users. The payment card transaction details sent over the network 14 are received by one or more servers 20 of the payment card processor 12 and processed by, for example, a payment authorization process 22 and/or forwarded to an issuing bank (not shown). The payment card transaction details are stored as payment transaction records 24 in a transaction database 26. As is well known the servers 20 include memory and processors for executing software components as described herein.

The most basic and common type of payment card transaction data is referred to as a level 1 transaction. The basic data fields of a level 1 payment card transaction are: i) merchant name, ii) billing zip code, and iii) transaction amount. Additional information, such as the date and time of the transaction and additional cardholder information may be automatically recorded, but is not explicitly reported by the merchant 16 processing the transaction. A level 2 transaction includes the same three data fields as the level 1 transaction, and in addition, the following data fields may be generated automatically by advanced point of payment systems for level 2 transactions: sales tax amount, customer reference number/code, merchant zip/postal code tax id, merchant minority code, merchant state code.

In one embodiment, the payment processor 12 further includes a system 200 for block chain digital currency stake delegation. In an embodiment, the system 200 facilitates the delegation by block chain digital currency holders of roles and responsibilities to the payment processor 12 as a trusted entity based on smart contracts. In an embodiment, system 200 can further delegate certain roles and responsibilities to other entities or act on their behalf based on a delegation model that can be captured in separate smart contracts.

In an embodiment, as regards blockchain digital currency stake delegation, any block chain digital currency holder can delegate a stake to a trusted entity, via a smart contract, with a default template that can be provided by the payment processor 12. Moreover, in an embodiment, the blockchain digital currency stake delegation can be defined in an on-chain smart contract that defines governance actions and processes, such as the definition of the validator node functions to be performed on behalf of block chain digital currency holders, distribution of fees, deviation triggers and reporting, arbitration, etc., to provide a standardized trust framework for adoption on the open permissionless block chain digital currency stake delegation network.

In an embodiment, the blockchain digital currency stake delegation binds block chain digital currency holder accounts and wallets and the payment processor 12 wherein the payment processor 12 acts on the behalf of block chain digital currency holders as a trusted entity with governance clauses executable upon predefined triggers (on a decentralized network with decentralized reserve function). In an embodiment, the blockchain digital currency stake delegation provides a robust on-chain framework designed to orchestrate authorization, clearance, settlement, secure key and token management, abuse handling, emergency breaks to counter malicious attacks, reporting, etc. in support of a healthy ecosystem that includes all stake holders.

In an embodiment, the blockchain digital currency stake delegation protocol can also stipulate that updates be provided to stake delegators on detection of validator abuses, network, reserve and liquidity updates within the boundaries of the blockchain digital currency stake delegation. In an embodiment, the blockchain digital currency stake delegation can set forth a fee structure, payable by the digital currency or fiat, based on the services provided via the payment processor 12 network, to cover costs such as gas, stake management, potential value added services, etc. The blockchain digital currency stake delegation can also further involve the delegation of certain roles and responsibilities to other entities such as issuer processors, merchants, acquirers, or involve acting on their behalf based on a trusted delegation structure supported by separate smart contracts.

### Operation

FIG. 1B shows operations A-G performed by the system 200 for block chain digital currency stake delegation according to an embodiment. In FIG. 1B, the operations A-G are shown as being performed in a block chain digital currency stake delegation infrastructure that includes merchant 16, acquirer 44, issuer 46, end user 48, ledger 50, abuse detector 52, block chain digital currency issuer 54, delegation engine 207a, and delegation manager 207b. The upper portion of the FIG. 1B diagram tracks operations 1-4 that are performed in the absence of a stake delegation. The lower left portion of the FIG. 1B diagram shows operations performed by a custodian that has received a stake delegation from merchant 16. The lower right portion of the FIG. 1B diagram shows operations that are performed by the block chain digital currency issuer.

Referring to FIG. 1B, at A, details of a transaction made by a block chain digital currency holder (e.g., customer) with the merchant 16 including a stake delegation (e.g., made by the merchant) are accessed from the merchant 16.

At B, transaction processing directions are determined in accordance with the stake delegation for executing the transaction. In an embodiment, the transaction processing directions are determined from related smart contracts. For example, in an embodiment, directions related to list of delegated functions, list of delegated parties, triggers and actions, execution logs and archives, reporting and communications, fee distribution and arbitration, etc., can be determined from the related smart contracts.

At C, a fee payment type selection for the transaction is accessed. In an embodiment, the fee payment type selection is based on a payment agreement associated with a management protocol associated with the delegated stake, and can include both on and off network fees. For example, in an embodiment, the delegator can determine whether the payment is accessed from an issuer bank or from a digital currency issuer (see FIG. 1B. at 2 and F).

At D, the stake delegation related to the transaction made with the merchant 16 is implemented and managed. In an embodiment, a delegation engine implements the delegation framework on the block chain digital currency network. In an embodiment, the delegated functions performed by the delegation engine can include delegated validator functions. In an embodiment, the delegation engine can fulfill these and other delegated roles and responsibilities on behalf of block chain digital currency validators, as defined in related smart contracts. In an embodiment, matters defined in related smart contracts can include but are not limited to: lists of delegated functions, lists of delegated parties, triggers and actions, execution logs and archives, reporting and communications, fee distribution and arbitration, etc. In an embodiment, a delegation manager, manages the delegation chain participants, validators or entities on the network such as issuer processors, merchants, and acquirers with delegation function partitions (e.g., for example those with specific roles and responsibilities as defined in related smart contracts). In an embodiment, the delegation management roles and responsibilities can include but are not limited to: entity registration/de-registration, delegation/de-delegation, grant/revoke, smart contracts management, auditing, voting, violation/abuse/status/rating reporting with penalty, arbitration, and enforcement, etc.

At E, an entry describing the transaction is made in a distributed ledger. In an embodiment, the distributed ledger can be a consensus of replicated, shared, and synchronized digital data geographically spread across multiple sites, countries, or institutions. In an embodiment, the distributed ledger may not have a central administrator or centralized data storage.

At F, a payment authorization request for the transaction is made. In an embodiment, the payment authorization request can be made to entities that include but are not limited to issuing banks or block chain digital currency issuers.

At G, a response to the payment authorization request is accessed. In an embodiment, as part of the response, an issuing bank or a block chain digital currency issuer, settles the transaction.

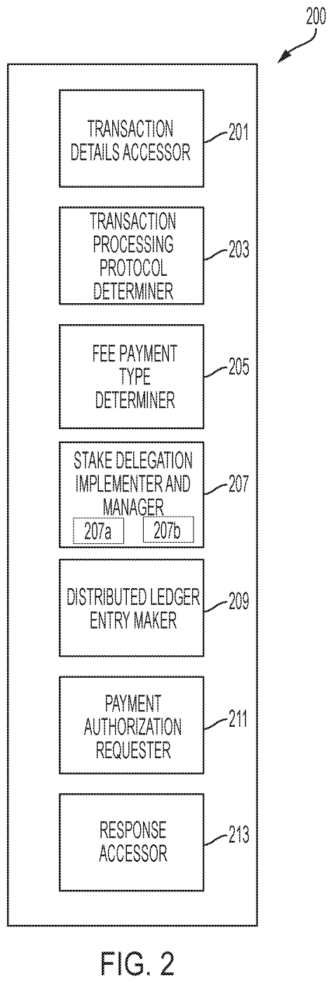

FIG. 2 shows components of system for block chain digital currency stake delegation according to an embodiment. In FIG. 2, system 200 includes transaction details accessor 201, transaction processing protocol determiner 203, fee payment type determiner 205, stake delegation implementer and manager 207, distributed ledger entry maker 209, payment authorization requestor 211, and response accessor 213.

Transaction details accessor 201 accesses details of a transaction made by a block chain digital currency holder (e.g., customer) including a stake delegation (e.g., made by the merchant) from the merchant 16.

Transaction processing protocol determiner 203 determines a transaction processing protocol in accordance with the stake delegation for executing the transaction. In an embodiment, the transaction processing directions are configured as defined in related smart contracts. For example, in an embodiment, directions related to list of delegated functions, list of delegated parties, triggers and actions, execution logs and archives, reporting and communications, fee distribution and arbitration, etc., are determined.

Fee payment type determiner 205 determines a fee payment type selection for the transaction. In an embodiment, the fee payment type selection is based on a payment agreement associated with the delegated stake management protocol, and can include both on and off network fees.

Stake delegation implementer and manager 207 implements and manages the stake delegation. In an embodiment, a delegation engine 207a implements the delegation framework on the block chain digital currency network. In an embodiment, the delegated functions performed by the delegation engine can include delegated validator functions. In an embodiment, the delegation engine can fulfill these and other delegated roles and responsibilities on behalf of block chain digital currency validators, as defined in related smart contracts. In an embodiment, matters defined in related smart contracts can include but are not limited to: lists of delegated functions, lists of delegated parties, triggers and actions, execution logs and archives, reporting and communications, fee distribution and arbitration, etc. In an embodiment, a delegation manager 207b, manages the delegation chain participants, validators or entities on the network such as issuer processors, merchants, and acquirers with delegation function partitions (e.g., for example those with specific roles and responsibilities as defined in related smart contracts). In an embodiment, the delegation management roles and responsibilities can include but are not limited to: entity registration/de-registration, delegation/de-delegation, grant/revoke, smart contracts management, auditing, voting, violation/abuse/status/rating reporting with penalty, arbitration, and enforcement, etc.

Distributed ledger entry maker 209 makes an entry in a distributed ledger that describes the transaction. In an embodiment, the distributed ledger can be a consensus of replicated, shared, and synchronized digital data geographically spread across multiple sites, countries, or institutions. In an embodiment, the distributed ledger does not have a central administrator or centralized data storage.

Payment authorization requestor 211 makes a payment authorization request for the transaction. In an embodiment, the payment authorization request can be made to entities that include but are not limited to issuing banks and block chain digital currency issuers.

Response accessor 213 accesses a response to the payment authorization request. In an embodiment, as part of the response, an issuing bank or a block chain digital currency issuer, settles the transaction.

FIG. 2 illustrates an example manner of implementing the system 200 of FIG. 1A. In an embodiment, one or more of the elements, processes, components and/or devices of the system 200 may be integrated, separated, re-arranged, omitted, eliminated and/or implemented in other manners. In an embodiment, the components of system 200 can be implemented using hardware, software, firmware and/or any combination thereof. In particular, components of system 200 can be implemented by one or more analog or digital circuit(s), logic circuits, programmable processor(s), application specific integrated circuit(s) (ASIC(s)), programmable logic device(s) (PLD(s)) and/or field programmable logic device(s) (FPLD(s)). In an embodiment, as regards software and/or firmware implementation of the system 200, at least one of the components of such is/are hereby expressly defined to include a non-transitory computer readable storage device or storage disk such as a memory, a digital versatile disk (DVD), a compact disk (CD), a Blu-ray disk, etc. including the software and/or firmware. It should be appreciated that, the example system 200 can include one or more elements, processes and/or devices in addition to, or instead of, those illustrated in FIG. 2, and/or may include more than one of any or all of the illustrated elements, processes and devices.

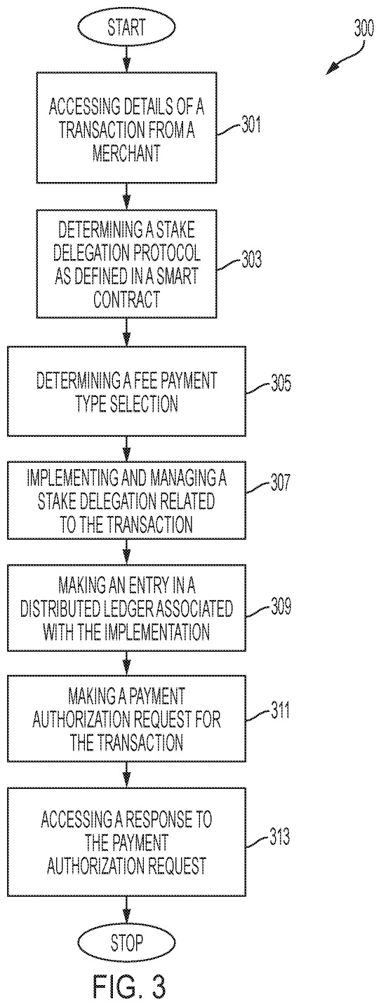

FIG. 3 is a flowchart 300 of a method for block chain digital currency stake delegation according to an embodiment. Referring to FIG. 3, the method includes at 301, accessing details of a transaction from a merchant. At 303, determining a stake delegation protocol as defined in a smart contract in accordance with the stake delegation. At 305, determining a fee payment type selection for the transaction. At 307, implementing and managing a stake delegation related to the transaction. At 309, making an entry in a distributed ledger associated with implementation of the stake delegation protocol. At 311, based on the fee payment type selection, making a payment authorization request for the transaction. At 313, accessing a response to the payment authorization request.

In an embodiment, the method further includes performing an audit to identify deviations from the stake delegation protocol. In an embodiment, implementing the stake delegation protocol causes the fulfillment of delegated roles and responsibilities of stake holders. In an embodiment, implementing the stake delegation protocol includes managing chain participants, validators or entities with delegation function partitions. In an embodiment, the stake delegation protocol controls the manner in which a trusted party acts on behalf of a delegator. In an embodiment, the smart contract governs behavior on the block chain digital currency network or on other payment networks. In an embodiment, the stake delegation includes a delegation extension that further delegates certain roles to other issuers, merchants, acquirers or processors. In an embodiment, the fee payment type is defined in a payment agreement associated with the delegation protocol.

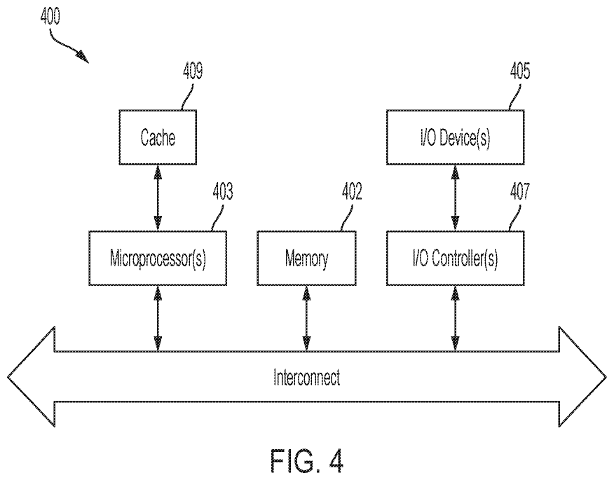

In an embodiment, the operations of the flowchart 300 can correspond to machine readable instructions of a program that can be executed by a processor of a computer system 400 such as is discussed with regard to FIG. 4 below. In some embodiments, the program and/or portions or parts thereof can be executed by a device other than a processor. The program can be stored on a non-transitory machine or computer readable storage medium such as a hard drive, a digital versatile disk (DVD), a read-only memory, a compact disk, a floppy disk, a Blu-ray disk, a cache, a random-access memory or other storage device. As used herein, the term non-transitory computer readable medium is intended to refer to computer readable storage devices and/or storage disks and to exclude propagating signals and to exclude transmission media. In some embodiments, the program can be embodied in firmware or dedicated hardware. In an embodiment, one or more of the operations of the flowchart can be performed without executing software or firmware. For example, one or more of the blocks may be implemented by one or more hardware circuits such as a Field Programmable Gate Array (FPGA), an Application Specific Integrated circuit (ASIC), a discrete and/or integrated analog and/or digital circuit, a comparator, an operational-amplifier (op-amp), a logic circuit, etc. It should be noted that the order of execution of the blocks of the flowchart of FIG. 3 may be changed. In addition, one or more of the blocks of the flowchart can be eliminated or added.

While one embodiment can be implemented in fully functioning computers and computer systems, various embodiments are capable of being distributed as a computing product in a variety of forms and are capable of being applied regardless of the particular type of machine or computer-readable media used to actually effect the distribution.

At least some aspects disclosed can be embodied, at least in part, in software. That is, the techniques may be carried out in a computer system or other data processing system in response to its processor, such as a microprocessor, execut-ing sequences of instructions contained in a memory, such as ROM, volatile RAM, non-volatile memory, cache or a remote storage device. Routines executed to implement the embodiments may be implemented as part of an operating system or a specific application, component, program, object, module or sequence of instructions referred to as “computer programs.” The computer programs typically include one or more instructions set at various times in various memory and storage devices in a computer, and that, when read and executed by one or more processors in a computer, cause the computer to perform operations necessary to execute elements involving the various aspects.

FIG. 4 shows a computer system 400 according to an embodiment. The computer system 400 can include a microprocessor(s) 403 and memory 402. In an embodiment, the microprocessor(s) 403 and memory 402 can be connected by an interconnect 401 (e.g., bus and system core logic). In addition, the microprocessor 403 can be coupled to cache memory 409. In an embodiment, the interconnect 401 can connect the microprocessor(s) 403 and the memory 402 to input/output (I/O) device(s) 405 via I/O controller(s) 407. I/O devices 405 can include a display device and/or peripheral devices, such as mice, keyboards, modems, network interfaces, printers, scanners, video cameras and other devices known in the art. In an embodiment, (e.g., when the data processing system is a server system) some of the I/O devices 405, such as printers, scanners, mice, and/or keyboards, can be optional.

In an embodiment, the interconnect 401 can include one or more buses connected to one another through various bridges, controllers and/or adapters. In one embodiment, the I/O controllers 407 can include a USB (Universal Serial Bus) adapter for controlling USB peripherals, and/or an IEEE-1394 bus adapter for controlling IEEE-1394 peripherals.

In an embodiment, the memory 402 can include one or more of: ROM (Read Only Memory), volatile RAM (Random Access Memory), and non-volatile memory, such as hard drive, flash memory, etc. Volatile RAM is typically implemented as dynamic RAM (DRAM), which requires power continually in order to refresh or maintain the data in the memory. Non-volatile memory is typically a magnetic hard drive, a magnetic optical drive, an optical drive (e.g., a DV D RAM), or other type of memory system which maintains data even after power is removed from the system. The non-volatile memory may also be a random access memory.

The non-volatile memory can be a local device coupled directly to the rest of the components in the data processing system. A non-volatile memory that is remote from the system, such as a network storage device coupled to the data processing system through a network interface such as a modem or Ethernet interface, can also be used.

In this description, some functions and operations are described as being performed by or caused by software code to simplify description. However, such expressions are also used to specify that the functions result from execution of the code/instructions by a processor, such as a microprocessor.

Alternatively, or in combination, the functions and operations as described here can be implemented using special purpose circuitry, with or without software instructions, such as using Application-Specific Integrated Circuit (ASIC) or Field-Programmable Gate Array (FPGA). Embodiments can be implemented using hardwired circuitry without software instructions, or in combination with software instructions. Thus, the techniques are limited neither to any specific combination of hardware circuitry and software, nor to any particular source for the instructions executed by the data processing system.

Although specific embodiments have been described above, these embodiments are not intended to limit the scope of the present disclosure, even where only a single embodiment is described with respect to a particular feature. Examples of features provided in the disclosure are intended to be illustrative rather than restrictive unless stated otherwise. The above description is intended to cover such alternatives, modifications, and equivalents as would be apparent to a person skilled in the art having the benefit of the present disclosure.

The scope of the present disclosure includes any feature or combination of features disclosed herein (either explicitly or implicitly), or any generalization thereof, whether or not it mitigates any or all of the problems addressed herein. Accordingly, new claims may be formulated during prosecution of an application claiming priority to this provisional application to any such combination of features. In particular, with reference to the appended claims, features from dependent claims may be combined with those of the independent claims and features from respective independent claims may be combined in any appropriate manner and not merely in the specific combinations enumerated in the appended claims.

What is claimed is:

1. A computer-implemented method, comprising:
accessing details of a transaction from a merchant;
determining a stake delegation protocol as defined in a smart contract in accordance with a stake delegation;
determining a fee payment type selection for the transaction;
implementing and managing the stake delegation protocol;
making an entry in a distributed ledger associated with implementation of the stake delegation protocol;
based on the fee payment type selection, making a payment authorization request for the transaction; and
accessing a response to the payment authorization request.

2. The method of claim 1, further comprising performing an audit to identify deviations from the stake delegation protocol.

3. The method of claim 1, wherein the implementing the stake delegation protocol causes a fulfillment of delegated roles and responsibilities of stake holders.

4. The method of claim 1, wherein the implementing the stake delegation protocol includes managing chain participants, validators or entities with delegation function partitions.

5. The method of claim 1, wherein the stake delegation protocol controls a manner in which a trusted party acts on behalf of a delegator.

6. The method of claim 1, wherein the smart contract governs behavior on a block chain digital currency network or on other payment networks.

7. The method of claim 1, wherein the stake delegation includes a delegation extension that further delegates certain roles to other issuers, merchants, acquirers or processors.

8. The method of claim 1, wherein a fee payment type is defined in a payment agreement associated with the delegation protocol.

9. A computer system, comprising:
one or more processing components;
one or more data storage components, at least one of the one or more data storage components including instructions that when executed cause at least one of the one or more processing components to:
access details of a transaction from a merchant;
determine a stake delegation protocol as defined in a smart contract in accordance with a stake delegation;
determine a fee payment type selection for the transaction;
implement and manage the stake delegation protocol;
make an entry in a distributed ledger associated with implementation of the stake delegation protocol;
based on the fee payment type selection, make a payment authorization request for the transaction; and
access a response to the payment authorization request.

10. The computer system of claim 9, further comprising causing the at least one of the one or more processing components to: perform an audit to identify deviations from the stake delegation protocol.

11. The computer system of claim 9, wherein implementing the stake delegation protocol causes a fulfillment of delegated roles and responsibilities of stake holders.

12. The computer system of claim 9, wherein implementing the stake delegation protocol includes managing chain participants, validators or entities with delegation function partitions.

13. The computer system of claim 9, wherein the stake delegation protocol controls a manner in which a trusted party acts on behalf of a delegator.

14. The computer system of claim 9, wherein the smart contract governs behavior on a block chain digital currency network or on other payment networks.

15. The computer system of claim 9, wherein the stake delegation includes a delegation extension that further delegates certain roles to other issuers, merchants, acquirers or processors.

16. The computer system of claim 9, wherein a fee payment type is defined in a payment agreement associated with the delegation protocol.

17. A computer-readable medium comprising computer readable instructions which when executed, cause a processor to at least:
access details of a transaction from a merchant;
determine a stake delegation protocol as defined in a smart contract in accordance with a stake delegation;
determine a fee payment type selection for the transaction;
implement and manage the stake delegation protocol;
make an entry in a distributed ledger associated with implementation of the stake delegation protocol;
based on the fee payment type selection, make a payment authorization request for the transaction; and
access a response to the payment authorization request.

18. The computer-readable medium of claim 17, further comprising causing a processor to at least: perform an audit to identify deviations from the stake delegation protocol.

19. The computer-readable medium of claim 17, wherein implementing the stake delegation protocol causes a fulfillment of delegated roles and responsibilities of stake holders.

20. The computer-readable medium of claim 17, wherein implementing the stake delegation protocol includes managing chain participants, validators or entities with delegation function partitions.
